(19) United States
(12) Patent Application Publication
(10) Pub. No.: US 2005/0133609 A1
(43) Pub. Date: Jun. 23, 2005

(54) Method for peening

(76) Inventor: Toru Matsubara, Nagaoka-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/508,083

(22) PCT Filed: Jul. 29, 2002
(86) PCT No.: PCT/JP02/07686

(30) Foreign Application Priority Data
Jun. 10, 2002 (JP) 2002-169155

(51) Int. Cl. B05D 1/00; B05B 17/00; A62C 5/02; F23D 11/40

(52) U.S. Cl. 239/1; 239/8; 239/398

(57) ABSTRACT

To provide a peening processing method which is superior in practical use and may perform a peening process extremely effectively and uniformly. In a peening processing method in which slurry into which liquid and shots are mixed and pressurized air are mixed to form injection material, the injection material is injected from an injection port of a nozzle so that the shots in the injection material are collided against a workpiece whereby mechanical characteristics of a surface of the workpiece are changed, the nozzle and the workpiece are moved relative to each other so that the injection material is injected to a predetermined region of the surface of the workpiece, furthermore, as the nozzle, the injection port is a slit-like injection port that is wide in a direction perpendicular to a relative moving direction of the nozzle and the workpiece and the nozzle having a structure where the injection material is injected in a parallel flow from the overall region of the slit-like injection port is adopted.

### TECHNICAL FIELD

The present invention relates to a peening processing method.

### BACKGROUND ART

As a process applied to a workpiece made of metal, a peening process (also called shot peening or the like) has been proposed in which a number of balls called shots (which are not always spherical) are injected at a high speed against a surface of the workpiece from an injection port of a nozzle to thereby collide a number of shots on the surface of the workpiece, and the surface of the workpiece is formed into a pear skin pattern by the collision of a number of shots, thus enhancing the surface hardness of the workpiece, prolonging a fatigue service life, enhancing an anti-wear property or decreasing a fluid resistance.

In this peening process, it is important to increase the collision energy of the shots to some extent (unless the collision energy is low, the increase of a compression residual stress in the vicinity of the surface of the workpiece or a depth at which the maximum residual stress occurs, which is important for the peening process, would be insufficient so that the effect by the peening process is degraded) and to collide the shots against the surface of the workpiece as uniformly as possible (if this is non-uniform, as a matter of course, the surface hardness of the workpiece or the like would become non-uniform).

Also, this peening process is categorized into two kinds of processes, i.e., a so-called dry blast method in which shots are injected simply by pressurized air and a so-called wet blast method in which shots are mixed with water and kept under a slurry condition and the slurry is injected by pressurized air. The latter process rather than the former process has the advantage such that the amount of splash shot is small and the working management is easy or because the pressurized air is kept under a condition surrounded by the slurry film, the acceleration by the expansion of the pressurized air is well applied to the shots to thereby increase the collision energy and so on.

By the way, in a conventional peening process, as shown in FIGS. 1(a) and 1(b), a so-called round nozzle having a circular injection port 22 is adopted as a nozzle and this round nozzle 21 is moved relative to the workpiece 23 so that the shots (slurry) injected from the injection port 22 of the round nozzle 21 is injected to the overall surface of the workpiece 23.

Also, if only the single nozzle 21 is used, as a matter of course, it takes long time to process a wide area. Accordingly, in some cases, a plurality of round nozzles 21 are juxtaposed and used (for example, in the condition that three round nozzles are juxtaposed).

However, the conventional peening processing method using the round nozzles 21 has the following disadvantage.

The injection port 22 of the round nozzle 21 is set up at a predetermined diameter or more so that the shot may be collided against a wide area to some extent. Accordingly, since the injection port 22 has the predetermined diameter or more, the shots to be injected from the injection port 22 are diffused radially as shown in FIG. 1(a) and collided against to the workpiece 23.

The thus radially diffused shots are collided substantially in a circular shape on the surface of the workpiece 23 as shown in FIG. 1(b). Accordingly, if the peening process is carried out while moving the round nozzle 21 relative to the workpiece 23 (the moving direction of the nozzle 1 in FIG. 1(b) is indicated by reference numeral 26), since a width in the moving direction is large in a region indicated by reference numeral 24 in FIG. 1(b) on the surface of the workpiece 23, the shots are collided for a long period of time correspondingly, whereas since the width in the moving direction is short in a region indicated by reference numeral 25 in FIG. 1(b) (regions near the end portions in a direction perpendicular to the moving direction of the round nozzle 21), the shots are collided for a short period of time correspondingly. Accordingly, the numbers of collisions of the shots against the workpiece 23 are different depending upon a place so that the peening process becomes non-uniform.

Furthermore, in case of the round nozzle 21, the shots are biased on the side of the circumferential wall of the injection port 22 due to the expansion effect of the pressurized air (so-called doughnut phenomenon). Thus, the shots are collided in a doughnut shape onto the surface of the workpiece 23. As expected, the peening becomes non-uniform.

Furthermore, since the region near the center of the injection port 22 and the region around this region are different in distance from the injection port 22 to the surface of the workpiece 23 due to the above-described diffusion, necessarily, the collision energy is different to thereby make the peening process non-uniform.

For this reason, for example, it is possible to adopt a method in which the distance between the injection port 22 and the workpiece 23 is kept long to thereby decrease the difference (rate) in collision energy of the shots as much as possible. However, in this case, as a matter of course, it is necessary to kept the processing space wide.

Also, it is possible to adopt a method in which the two adjacent round nozzles 21 are positioned close to each other so that the shots injected from the nozzles 21 are collided in a region where a small number of shots collide each other. However, this method is a method in which after all, the same region is subjected to the peening process by using the two round nozzles 21 and is an extremely ineffective method.

Furthermore, in case of this method, since the shots injected from the two round nozzles 21 are collided against each other, the collision energy is degraded when the shots are collided against the workpiece, it is likely that the peening process would be non-uniform and the injection energy of the shots is lost.

Also, in order to prevent the diffusion of the shots, it is possible to propose a method in which the injection path of the shots within the round nozzle 21 is elongated. However, in this case, there is a problem that the nozzle 21 is enlarged in size or a problem that the injection velocity of the shots is degraded due to the frictional resistance between the inner wall of the injection path and the shot and necessarily, the above-described collision energy is decreased.

In order to solve the above-noted problems, as a result of the repeated experiments, the present invention is a technology to confirm and establish that a nozzle having a wide injection port is adopted whereby the peening process may be performed extremely effectively and uniformly.

### DISCLOSURE OF THE INVENTION

The essence of the invention will now be described with reference to the accompanying drawings.

A peening processing method in which slurry into which liquid and shots are mixed and pressurized air are mixed to form injection material 9, the injection material 9 is injected from an injection port 2 of a nozzle 1 so that the shots in the injection material 9 are collided against a workpiece 3 whereby mechanical characteristics of a surface of the workpiece 3 are changed, is characterized in that the nozzle 1 and the workpiece 3 are moved relative to each other so that the injection material 9 is injected to a predetermined region of the surface of the workpiece 3, furthermore, as the nozzle 1, the injection port 2 is a slit-like injection port 2 that is wide in a direction perpendicular to a relative moving direction of the nozzle 1 and the workpiece 3 and the nozzle 1 having a structure where the injection material 9 is injected in a parallel flow from the overall region of the slit-like injection port 2 is adopted.

Also, the peening processing method according to claim 1 is further characterized in that a nozzle 1 for injecting the injection material 9 uniformly from an overall region of the slit-like injection port 2 is adopted as the nozzle 1.

Also, the peening processing method according to claim 1 is further characterized in that the injection material 9 is injected from a normal direction of the surface of the workpiece 3 as much as possible.

Also, the peening processing method according to claim 2 is further characterized in that the injection material 9 is injected from a normal direction of the surface of the workpiece 3 as much as possible.

Also, the peening processing method according to any one of claims 1 to 4 is further characterized in that the injection material 9 is injected from a normal direction of the surface of the workpiece 3 as much as possible while both the nozzle 1 and the workpiece 3 are moved.

Also, a peening processing method in which slurry into which liquid and shots are mixed and pressurized air are mixed to form injection material 9, the injection material 9 is injected from an injection port 2 of a nozzle 1 so that the shots in the injection material 9 are collided against a workpiece 3 whereby mechanical characteristics of a surface of the workpiece 3 are changed, is characterized in that both the nozzle 1 and the workpiece 3 are moved relative to each other so that the injection material 9 is injected to a predetermined region of the surface of the workpiece 3, furthermore, as the nozzle 1, the injection port 2 is a slit-like injection port 2 that is wide in a direction perpendicular to a relative moving direction of the nozzle 1 and the workpiece 3 and the nozzle 1 having a structure where the injection material 9 is injected in a parallel flow from the overall region of the slit-like injection port 2 is adopted.

### BRIEF DESCRIPTION OF THE DRAWINGS

FIG. 1(a) is an illustrative perspective view of a conventional example.

FIG. 1(b) is an illustrative enlarged plan view of a surface of a conventional workpiece 23.

FIG. 2 is an illustrative perspective view of the present embodiment.

FIG. 3 is an illustrative side elevational cross-sectional view.

FIG. 4(a) is a model view of a slurry for theoretically illustrating a degree of effective utilization of shots in Experimental Example 1.

FIG. 4(b) is an illustrative enlarged view of a surface of the workpiece 3 under the condition of 100% coverage.

FIG. 4(c) is a model view in the case where in Experimental Example 1, 100% shots are uniformly collided against the surface of the workpiece 3.

### BEST MODE FOR EMBODYING THE INVENTION

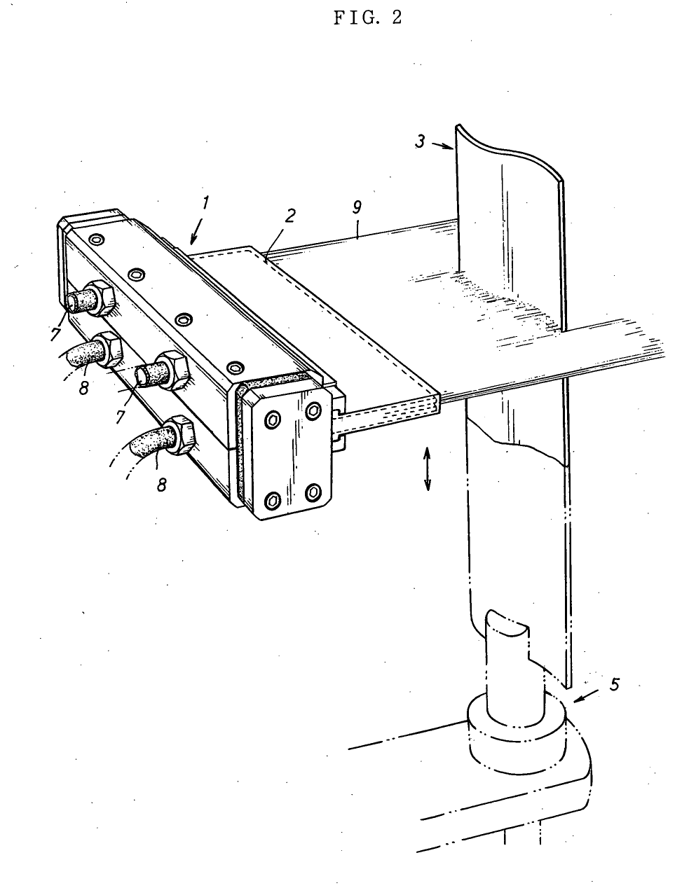

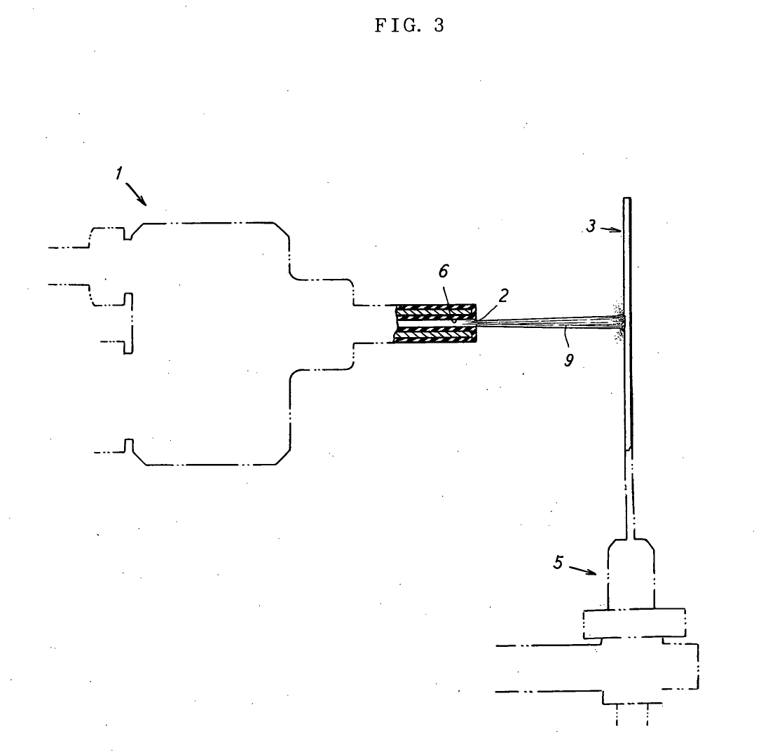

FIGS. 2 to 4 show one embodiment of the present invention and will now be described.

In the embodiment, in a peening processing method in which slurry into which liquid (water) and shots (for example, glass balls) are mixed and pressurized air are mixed to form injection material 9, the injection material 9 is injected from an injection port of a nozzle 1 so that the shots in the injection material 9 are collided against a workpiece 3 (for example, fins of an air-craft engine) whereby mechanical characteristics of a surface of the workpiece 3 are changed, a method is adopted in which the nozzle 1 and the workpiece 3 are moved relative to each other (for example, the workpiece 3 is moved relative to the nozzle 1 or the nozzle 1 is moved to the workpiece 3) so that the injection material 9 is injected to a predetermined region of the surface of the workpiece 3, and furthermore, as the nozzle 1, the injection port 2 is a slit-like injection port that is wide in a direction perpendicular to a relative moving direction of the nozzle 1 and the workpiece 3 and the nozzle 1 having a structure where the injection material 9 is injected in a parallel flow from the overall region of the slit-like injection port 2 is adopted.

The workpiece 3 is maintained in an upright condition on a rotary jig 5.

The workpiece 3 is rotated under the upright condition by the rotation of this rotary jig 5.

The nozzle 1 is arranged so as to be moved back and forth, up and down and right and left relative to the workpiece 3. The shots may be injected over the full surface of the workpiece by the rotation of the rotary jig 5 and the movement of this nozzle 1.

Also, the nozzle 1 is arranged so as to be slanted relative to the workpiece 3 as desired so that the shots (injection material 9) may be injected in a normal direction of the shot injected surface of the workpiece 3 as much as possible by the slant.

The rotation of the rotary jig 5 and the movement and the slant of the nozzle 3 are controlled in a concentrated manner by an NC control (numerical control) so that the injection of the shots to the workpiece 3 may be performed in a proper manner. Also, the rotation of the rotary jig 5 and the movement and the slant of the nozzle 3 are selected so that the distance from the slit-like injection port 2 of the nozzle 1 to the surface of the workpiece 3 may be kept substantially constant.

Also, the nozzle 1 is arranged so as to inject uniformly the shots from the overall region of the slit-like injection port 2.

Also, a mixture portion (not shown) for mixing the slurry and the pressurized air is incorporated into the nozzle 1. A guide injection path 6 having a predetermined length in which the injection direction of the shots (slurry) is straight as much as possible is provided from the mixture portion to the slit-like injection port 2.

The width of the slit-like injection port 2 is set up to a width by which the shots may be injected over the full surface of a predetermined portion (a desired portion to be peened) of the workpiece 3 for a shot period of time as much as possible. Incidentally, the width of the slit-like injection port 2 may exceed the width of the workpiece 3.

In the drawings, reference numeral 7 designates a slurry supply portion and numeral 8 designates a pressurized air supply portion.

A result of each experiment of the present embodiment will now be described.

### EXPERIMENTAL EXAMPLE 1

A nozzle 1 having a slit-like injection port 2 which was 100 mm wide and 2.5 mm long was used.

Glass balls (commercial name: “M-10” made of Potters/Barotini Co.) having a granular size of about 150 to 90 μm were used as the shots.

The shots were handled under the slurry condition mixed with water. A concentration of the shots in the slurry was set at 40%.

A pump pressure of the pressurized air was set at 0.3 MPa and a slurry flow rate was set at 10 liter/min, respectively, so that the shots were injected to the workpiece 3 at a pressure of 0.4 MPa.

When the experiments were repeated under those conditions, it was confirmed that a condition of 100% coverage at an intensity of 2.1 mm (a condition that the shots are uniformly collided every one time over the surface (surface to be machined) of the workpiece 3) could be realized at a peening processing velocity of 200 mm/s (according to a measurement of an intensity measurement instrument).

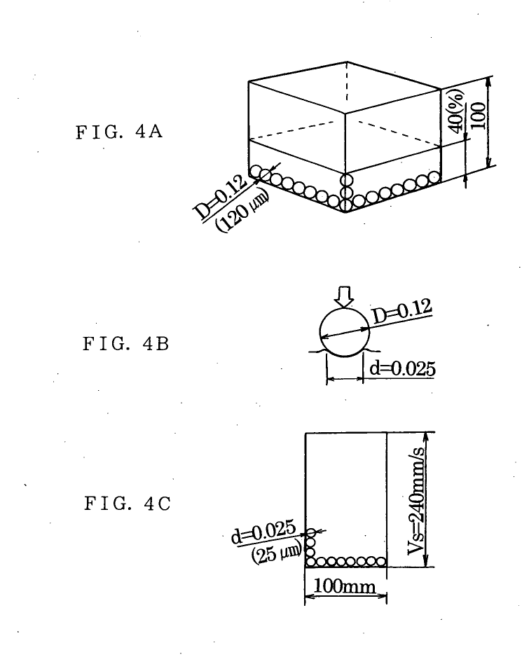

By the way, if it is assumed that the shots in the slurry be arranged and aligned in a rectangular body as shown in FIG. 4(a) and an average granular size of the shots be 120 μm, the slurry amount Qs flowing for one second means the slurry amount per one minite/60 seconds=10 (liter)/second=0.166 (liter)=166 cm³/sec), and the number of shots n injected for one second is Qs×concentration of the shots/volume of shots (in terms of a cubic body)=166 (cm³/second)×40(%)/(120 (μm))³=38425926 (pieces/second), i.e., about 40 million pieces/second.

On the other hand, when the surface of the workpiece 3 kept under this 100% coverage condition was observed by a microscope, it was confirmed that the collision damage of average granular size of 25 μm (see FIG. 4(b)).

If one piece of shot may form a collision damage of 25 μm, the length through which the shots of 38425926 pieces/second may form the collision damage over the full surface of the workpiece 3 having the width of 100 mm is (shot number/(100 (mm)/diameter of collision damage)/length of collision damage=(38425926 (pieces/sec)/(100 (mm)/25 (μm)))=240 (mm/second). Namely, theoretically, if 100% shots may collide onto the surface of the workpiece 3 uniformly, it is possible to perform the peening process on the workpiece 3 having the width 100 mm over 240 mm for one second (peening processing velocity Vs=240 mm/s. see FIG. 4(c)).

According to the foregoing experimental example 1, the actually measured peening processing velocity was 200 mm/s. This value is about 83% of the theoretical peening processing velocity Vs=240 mm/s. Accordingly, it is safe to say that it was confirmed that the shots were collided against the workpiece 3 at an extremely high efficiency rate in the embodiment.

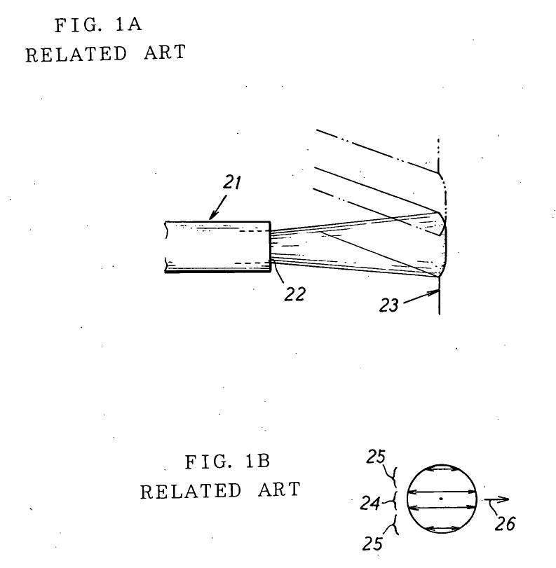

In contrast, in the conventional method using the round nozzle 21, as described above, the number of the effective shots collided against the workpiece 23 is considered very low for the reasons why the shots are collided only for a short period of time at the end portions (indicated by reference numeral 25 in FIG. 1(b)) in the direction perpendicular to the moving direction of the round nozzle 21, the shots are biased on the side of the circumferential wall of the injection port 22 of the round nozzle 21 due to the expansion effect of the pressurized air (doughnut phenomenon), the central portion of the injection port 22 and the peripheral portion thereof are different in distance from the injection port 22 to the surface of the workpiece 23 and also different in collision energy due to the diffusion of the shot (injection material) and so on.

### EXPERIMENTAL EXAMPLE 2

The peening process was applied to an SUS plate (workpiece) having a hardness HV45, which was 80 mm long, 2 mm wide and 1 mm thick. A warpage (intensity) of this SUS plate was measured by a dial gauge. The results were compared between the method according to this embodiment (described as a wide gun in the table) and the conventional method using the round nozzle (described as a round gun in the table).

A nozzle having a slit-like injection port that is 60 mm wide and 2.5 mm long was used as the wide gun and a nozzle having a circular injection port having an inner diameter 12.7 mm was used as the round gun.

The experiments were repeated while varying the moving velocity of the nozzle (gun) to the workpiece and the air pressure for injecting the slurry containing the shots.

The experimental results are shown in Table 1 and Table 2.

[image]

[image]

In order to meet the conditions of the coverage 100% and the intensity 2.1 mm at 1.0 second (the condition that the variation of the intensity was suppressed within 10% even by the continuation of the peening process), the wide gun needed the air pressure of 0.25 MPa and the round gun needed the air pressure of 0.45 MPa.

Namely, according to Experimental Example 2, it was confirmed that according to this embodiment, it was possible to effectively perform the peening process even at a low air pressure (low output), that is, it was possible to perform the peening process at a high efficiency rate.

By the way, from the results of Experimental Example 2, the efficiency of this embodiment and that of the conventional method were compared with each other.

This comparison was made under the condition of substantially the same intensity and process velocity and the 100% coverage, i.e., at O sign in Tables 1 and 2.

The process conditions according to this embodiment were as follows:

| | | |
|---|---|---|
| Air pressure | 0.25 | MPa |
| Air consumption rate | 2,030 | Nl/min |
| Slurry flow rate | 6.8 | L/min |
| Process effective width | 50 | mm |

The process conditions according to the conventional method were as follows:

| | | |
|---|---|---|
| Air pressure | 0.45 | MPa |
| Air consumption rate | 860 | Nl/min |
| Slurry flow rate | 27.8 | L/min |
| Process effective width | 8 | mm |

Incidentally, the intensity was about 2.1 mm and the process velocity was 70 mm/sec. These are substantially the same.

Presumably, in the comparison in process time, {process area according to wide gun}/{process area according to round gun} was (70 (mm/sec)×50 (mm))/(70 (mm/sec)×8 (mm))=6.25. Namely, the process speed according to this embodiment was 6.25 times higher than that according to the conventional method.

Comparing the air amount needed for this process time, since 6.25:1=2,030 (Nl/min):860 (Nl/min), the needed air amount according to this embodiment was 6.25 times less than that according to the conventional method. Accordingly, it is safe to say that the pressurized air was effectively consumed according to this embodiment.

Also, comparing the shot amount needed for the process time (at the same shot concentration in the slurry), since 6.25:1=6.8 (L/min):27.8 (L/min), the present embodiment needed only one 25.6th of the conventional method. Accordingly, it is safe to say that the shots were extremely effectively consumed according to the present embodiment.

As described above, according to Experimental Example 2, it was confirmed that according to the present embodiment, the process speed was high even if the pressure of the pressurized air was low, and furthermore, the pressurized air and the shots (slurry) could be extremely effectively utilized.

### EXPERIMENTAL EXAMPLE 3

This was substantially the same example as Experimental Example 2 but the warpage of each portion of the workpiece was measured.

Also, the air pressure for injecting the slurry containing the shots were set so as to warp the workpiece substantially to the same extent by the wide gun and the round gun.

Also, the experiments were repeated while varying the moving velocity of the nozzle to the workpiece.

The experimental results are shown in Table 3 below.

[image]

It was conformed that in the round gun (conventional), the machining amount was considerably different between the right and left side portion (peripheral edge portions) in the direction perpendicular to the moving direction and the central portion, whereas in the wide gun (this embodiment), the difference in machining amount was small between the right and left side portion in the direction perpendicular to the moving direction and the central portion and in addition the average region was extremely wide.

Namely, according to Experimental Example 3, it was confirmed that in this embodiment, it was possible to attain the uniform peening process, and particularly, it was very effective in the case here the workpiece was subjected to the area process.

Incidentally, according to the conventional method using the round gun, it is necessary to further apply the peening process to the right and left side portions in the direction perpendicular to the moving direction where the machining amount is insufficient. However, it is very troublesome and hard to inject the shots (injection material 9) so that the machining amount in the right and left side portions and the machining amount in the central portion are kept substantially the same.

### EXPERIMENTAL EXAMPLE 4

The peening process was performed while varying the air pressure and the surface roughness was measured.

The same wide gun as that of Experimental Example 2 was used. Two kinds of the round guns, i.e., the same round gun as that of Experimental Example 2 (described as round gun ½ in the table) and the round gun having the circular injection port having an inner diameter of 9.7 mm (described as round gun ⅜ in the table) were used.

The distance between the injection port and the workpiece was a minimum distance through which the peening process might be performed uniformly (which was a confirmation result by a preliminary experiment).

The experimental result is shown in Table 4 below.

[image]

It was confirmed that the surface roughness was large substantially in proportion to the elevation of the air pressure by the wide gun but the elevation of the surface roughness was slow down when the elevation of the air pressure by the round gun reached some extent or more.

Namely, according to Experimental Example 4, it was confirmed that in this embodiment, even if the air pressure was high, it was possible to effectively perform the peening process, and accordingly, it was possible to perform the peening process at a high speed and at a high efficiency rate.

Incidentally, according to the conventional method using the round gun, in the case where the air pressure was high, the energy loss was remarkable, and it was difficult to perform the peening process at a high speed and at a high efficiency rate.

According to each experimental result, it was confirmed that the present embodiment was superior in energy efficiency and shot efficiency, it was possible to extremely uniformly perform the peening process and as a result, the process speed was high.

As described above, according to the present embodiment, it is possible to provide a peening processing method that is superior in practical use and in which it is possible to collide the shots within the injection material 9 injected against the workpiece 3 at an extremely high efficiency rate, thereby shortening the peening process time and saving the energy for injecting the shots.

Also, since the shots (injection material 9) are not excessively injected, it is possible to prevent, without fail, any fragile fracture of the workpiece 3 due to the excessive application of the peening process (overpeening which would occur at about the coverage 600).

Also, since the shots are effectively collided against the workpiece 3, the wear of the shots is prevented due to the fact that the shots are collided against each other, thus making it possible to attain the long service life of the shots.

Also, since the shots are injected uniformly in a parallel flow from the slit-like injection port 2, unlike the case where a plurality of round nozzles are juxtaposed, there is no injection bias of the shots in the width direction of the nozzle 1, as a matter of course, thereby making it possible to perform the uniform peening on the surface of the workpiece 3.

Also, because of the method to perform the peening process while moving both the nozzle 1 and the workpiece 3, it is possible to set the positional relation between the nozzle 1 and the workpiece 3 rapidly and suitably. Also in this sense, it is possible to perform the peening process for a short period of time.

### INDUSTRIAL APPLICABILITY

When the experiments of the peening process adopting the method in which the nozzle 1 and the workpiece 3 are moved relative to each other so that the injection material 9 (the mixture of the pressurized air and the liquid into which the shots are mixed) is injected to a predetermined portion of the surface of the workpiece 3 and furthermore, the injection material 9 is injected from the slit-like injection port 2 that is wide in the direction perpendicular to the above-described relative moving direction and the above-described nozzle 1 has a structure in which the injection material 9 is injected in the parallel flow from the overall region of the slit-like injection port 2 are conducted, it is confirmed that the shots are uniformly collided on the surface of the workpiece 3 for an extremely short period of time (confirmed by a measurement instrument for measuring the peening condition).

Presumably, this is the reason why, since the injection port 2 is the slit-like injection port 2 that is wide in the direction perpendicular to the above-described relative moving direction, unlike the round nozzle, the shots are uniformly collided onto the surface of the workpiece 3 in the direction perpendicular to the above-described relative moving direction, and furthermore, and since the injection material 9 is injected in a parallel flow from the overall region of the slit-like injection port 2, also in this point, the shots within the injection material 9 are uniformly collided against the surface of the workpiece 3 so that it is unnecessary to collide the shots while directing the injection port of the nozzle to the same portion many times.

Counting the effective utilization rate of the shots, the shots were collided effectively to the surface of the workpiece 3 at an extremely high effective consumption rate that was about 80%.

Also, since the effective utilization rate of the shots is high, as a mater of course, it is possible to save the injection energy of the shot. Furthermore, it is possible to prevent the injection of the extra shots while shortening the time to peen. It is therefore possible to avoid, without fail, the condition that the number of the collision of the shots is excessive to reduce the surface hardness (overpeened).

As described above, according to the present invention, it is possible to provide a peening processing method that is superior in practical use which may perform extremely effectively the peening process uniformly.

1. A peening processing method in which slurry into which liquid and shots are mixed and pressurized air are mixed to form injection material, the injection material is injected from an injection port of a nozzle so that the shots in the injection material are collided against a workpiece whereby mechanical characteristics of a surface of the workpiece are changed, characterized in that the nozzle and the workpiece are moved relative to each other so that the injection material is injected to a predetermined region of the surface of the workpiece, furthermore, as a nozzle, the injection port is a slit-like injection port that is wide in a direction perpendicular to a relative moving direction of the nozzle and the workpiece and the nozzle having a structure where the injection material is injected in a parallel flow from the overall region of the slit-like injection port is adopted.

2. The peening processing method according to claim 1, further characterized in that as the nozzle, a nozzle having a structure where a mixture portion for mixing the slurry and the pressurized air is provided in an inner portion, and a guide injection path having the same cross-section as a cross-section of the wide slit-like injection port and having a predetermined length by which the injection direction of the injection material is straight as much as possible is provided until the slit-like injection port corresponding to the workpiece width from the mixture portion is adopted.

3. The peening processing method according to claim 2, further characterized in that a nozzle for injecting the injection material uniformly from an overall region of the slit-like injection port is adopted as the nozzle.

4. The peening processing method according to claim 3, further characterized in that the injection material is injected from a normal direction of the surface of the workpiece as much as possible.

5. The peening processing method according to claim 4, further characterized in that the workpiece is retained under an upright condition to a rotary jig and rotated under the upright condition by the rotation of the rotary jig.

6. The peening processing method according to claim 5, further characterized in that the nozzle is slanted relative to the workpiece as desired.

7. The peening processing method according to claim 6, further characterized in that the nozzle may be moved back and forth, up and down and right and left relative to the workpiece.

8. The peening processing method according to claim 7, further characterized in that the movement and slant of the nozzle and the rotation of the rotary jig are controlled so that the distance from the injection port of the nozzle to the surface of the workpiece may be kept substantially constant.
